(19) United States
(12) Patent Application Publication
(10) Pub. No.: US 2010/0138874 A1
(43) Pub. Date: Jun. 3, 2010

(54) Apparatus and system for interactive seat selection

(76) Inventor: Peter R. Deutschman, Lake Forest, CA (US)

Correspondence Address: KELLEY DRYE & WARREN LLP, 3050 K STREET, NW, SUITE 400, WASHINGTON, DC, 20007, US

(21) Appl. No.: 12/285,331

(22) Filed: Oct. 2, 2008

Related U.S. Application Data
(60) Provisional application No. 60/960,554, filed on Oct. 3, 2007.

(51) Int. Cl. H04N 5/445

(52) U.S. Cl. 725/60

(57) ABSTRACT

Applicant has developed a novel apparatus and system allowing users to view seating configurations at performance and other venues (e.g., arenas, theaters, stadiums, etc) by presenting a video segment that shows the view of the stage from the selected seat or section, a view of the seat or section from the stage, and by providing a dynamic sense of the distance of the seat or section from the stage and in relation to others seats or sections.

### CROSS-REFERENCE TO RELATED APPLICATIONS

The present invention relates to, and is entitled to the benefit of the earlier filing date and priority of, Application No. 60/960,554, filed on Oct. 3, 2007, which is herein incorporated by reference as if fully set forth.

### BACKGROUND OF THE INVENTION

Most performance venues publish websites or other mediums that provide users with a map of the seating configuration within the venue to help potential ticket purchasers determine which seats they wish to purchase. Some venues additionally provide digital photos depicting the view of the stage or performance area from a particular seat or seating area. However, the photos are static and two dimensional and do not fully provide a potential purchaser with a clear sense of how far the seat or seating area may be from stage or performance area. At least one venue has a web-site which provides a computer generated view from both the seat and the performance area. However the computer generated view does not provide a realistic sense of the actual view that the potential purchasers might have.

There are several known applications providing web based seat perspective tools, such as:

http://www.nashvillesymphony.org/main.taf?p=1,4,2,3,1;

http://www.seatadvisor.com/cgi/lookup venue dyn.pl?venue code=1232;

and

http://www.staplescenter.com/home/default.sps.

The above examples are limited to providing still photographic or computer generated 3D views of a performance area from a seat or section within the venue.

The web site for Nissan Pavillion, Bristow Va., http://www.livenation.com/venue/getVenue/venueld/793/ provides a seating chart that employs computer generated graphic images of the various seating areas along with the ability to move the image left or right with your mouse. The reference does not disclose an apparatus and system offering video views of each section which grants the user a more realistic assessment of where they are sitting along with their view from the stage as in an embodiment of the present invention. An embodiment of the present invention provides at least two views and a closer approximation of the total venue size and depth, hence a more realistic view and easier to see distance from the stage along a 360 degree view of the venue. In addition, an embodiment of the present invention actually can show the user the exact seat which is ideal when the user is using 2D seating charts as opposed to 3D renderings which are used at this venue. One embodiment of the present invention comprises a “navigator” that allows for zooming in and out along with the ability to pan left, right, up and down when viewing a venue's seating chart. The views disclosed by this reference only allow for viewing a computer generated image from left and right and vice-versa.

The web-site for the University of Virginia, John Paul Jones Arena discloses a seat finder that allows the user to see the computer generated view from the row the user is sitting in, and a 180 degree computer generated view of sections as opposed to views from specific seats. The reference does not disclose an apparatus and system offering video views of each section which grants the user a more realistic assessment of where they are sitting along with their view from the stage as in an embodiment of the present invention. This disclosure is also limited as discussed in the previous reference.

U.S. application Ser. No. 09/750,445 (US 2002/0082879) to Miller et al. discloses the use of still photographs to illustrate the view from a user's seat. An embodiment of the present invention offers video views as opposed to a PDF which shows the view from a seat via a still photograph.

U.S. Pat. No. 5,333,257 to Merrill et al. discloses a use limited to graphic approximations of the views from seats a user selects when purchasing tickets. An embodiment of the present invention offers video views as opposed to a PDF which shows the view from a seat via a still photograph.

U.S. Pat. No. 5,408,417 to Wilder discloses a ticketing kiosk or terminal with a touch screen to allow users to purchase tickets. This reference discloses only the ability of a user to see the view of the field or stage from their approximate seating location. There is no disclosure of a video based viewing experience. An embodiment of the present invention offers video views as opposed to a PDF which shows the view from a seat via a still photograph.

What is not disclosed in the references is an apparatus and system that uses video rather than photo or computer generated images and provides a more dynamic view of the seat, from the seat to the stage, the stage to the seat, and between the two.

What is needed in the industry is an apparatus and system that through video segments will show a dynamic view from both the stage or performance area the general or specific area where a seat is located, as well as provide a sense of the distance between the seat and the performance area.

What is needed in the industry is an apparatus and system to provide users with dynamic video segment depiction of the distance and perspective between a seat or seating area and a performance area within a performance venue so that a user can make a more informed choice when selecting seats purchasing tickets to the venue.

What is needed in the industry is a seat locator tool that allows a customer to quickly and easily input row information into a seat selection tool. Using this tool, a customer was able to enter all the information of a larger venue (2000 seats) into the apparatus and system according to one embodiment of the present invention in a little over an hour.

It is an advantage of an embodiment of the present invention to provide an apparatus and a system allowing a user to see views from both stage and seating area and the relation between the two perspectives.

It is another advantage of an embodiment of the present invention to provide an apparatus and a system allowing a user to zoom and pan seating charts with a navigator tool.

It is an advantage of an embodiment of the present invention to provide an apparatus and a system allowing a user to search and find exact seat locations within multiple seating charts.

### SUMMARY OF THE INVENTION

Responsive to the foregoing challenges, Applicant has developed a novel apparatus and system allowing users to view seating configurations at performance and other venues (e.g., arenas, theaters, stadiums, etc) by presenting a video segment that shows the view of the stage from the selected seat or section, a view of the seat or section from the stage, and by providing a dynamic sense of the distance of the seat or section from the stage and in relation to others seats or sections. The video segment can be created by using an indoor remote controlled blimp that has an attached to a remote controlled camera, or other apparatus with a camera such as a crane, or guide wires. The video can be viewed on the Internet or other digital media platform, and can be integrated into or with a seat selection and ticket purchase program. An embodiment of the present invention uses video rather than photo or digitized images, and provides a more dynamic view of the seat, from the seat to the stage, the stage to the seat, and between the two.

An embodiment of the present invention is a system for the interactive selection of seats, comprising a video segment created by moving a video recording device from a stage to at least one seat in a venue, from at least one seat to a stage, or both, a storage medium storing the video segment, a video player module enabling a user to view the video segment, and a selection tool to allow the user to select a seat at a venue and play the video segment assigned to the seat. The video recording device may be a digital camera. The video recording device may attached to a blimp, guidewires, a crane, or any other suitable apparatus to record the video segment.

An embodiment of the present invention is a method for the interactive selection of seats, comprising the steps of creating a video segment by moving a video recording device from a stage to at least one seat in a venue, from at least one seat to a stage, or both, storing the video segment in a storage medium, enabling a user to view the video segment using a video player module, allowing a user to select a seat at a venue and play the video segment assigned to the seat.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention and, together with the detailed description, serve to explain the principles of the present invention.

### BRIEF DESCRIPTION OF THE DRAWINGS

In order to assist in the understanding of this invention, reference will now be made to the appended drawings, in which like reference characters refer to like elements.

FIG. 1 is a visual representation of a “Landing” screen shot according to an embodiment of the present invention.

FIG. 2 is a visual representation of a “Seat Buddy” screen shot according to an embodiment of the present invention.

FIG. 3 is a visual representation of a “Seat Buddy (zoom)” screen shot according to an embodiment of the present invention.

FIG. 4 is a visual representation of a “Seat Buddy (rollover)” screen shot according to an embodiment of the present invention.

FIG. 5 is a visual representation of a “video” screen shot according to an embodiment of the present invention.

FIG. 6 is a visual representation of a “Seat Locator” screen shot according to an embodiment of the present invention.

FIG. 7 is a visual representation of a “Seat Locator result” screen shot according to an embodiment of the present invention.

FIG. 8 is a visual representation of a (“Help”) screen shot according to an embodiment of the present invention.

FIGS. 9-15 are frames from the video segment according to an embodiment of the present invention.

FIGS. 16-18 illustrate the use of a remote control blimp for creating the video segments according to an embodiment of the present invention.

FIG. 19 is a block diagram illustrating the system of an embodiment of the present invention.

### DETAILED DESCRIPTION OF THE INVENTION

The apparatus and system of an embodiment of the present invention comprises a video recording device, video segments, video segment player, seat navigator tool, software and/or hardware to enable the user to select seats and enable a video segment, and seating charts. One embodiment of the present invention may also comprise a seat or section locator tool.

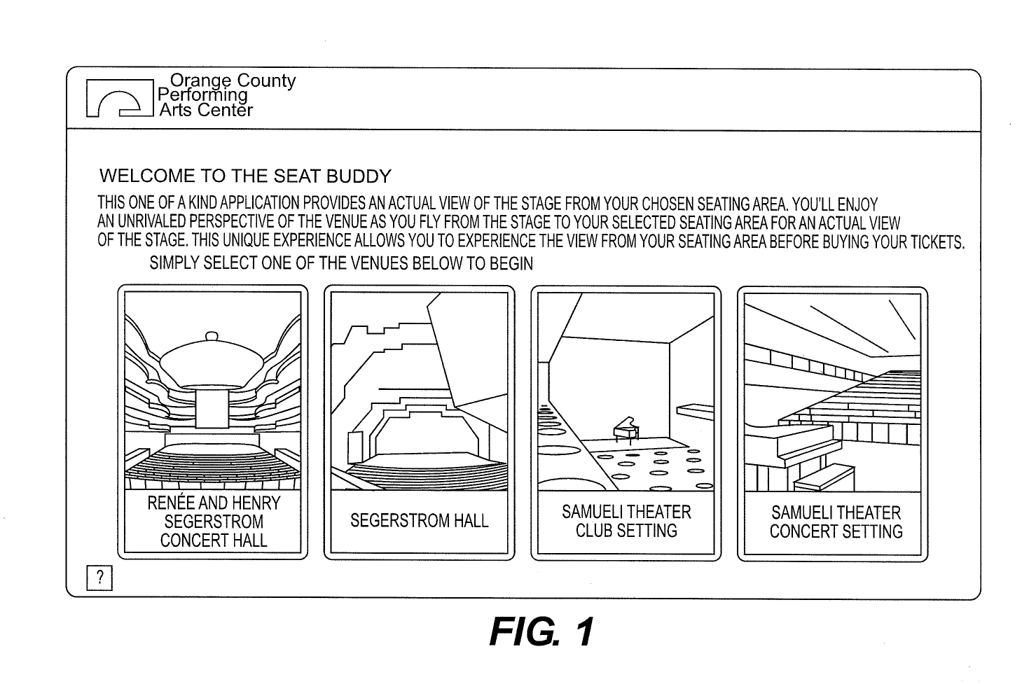

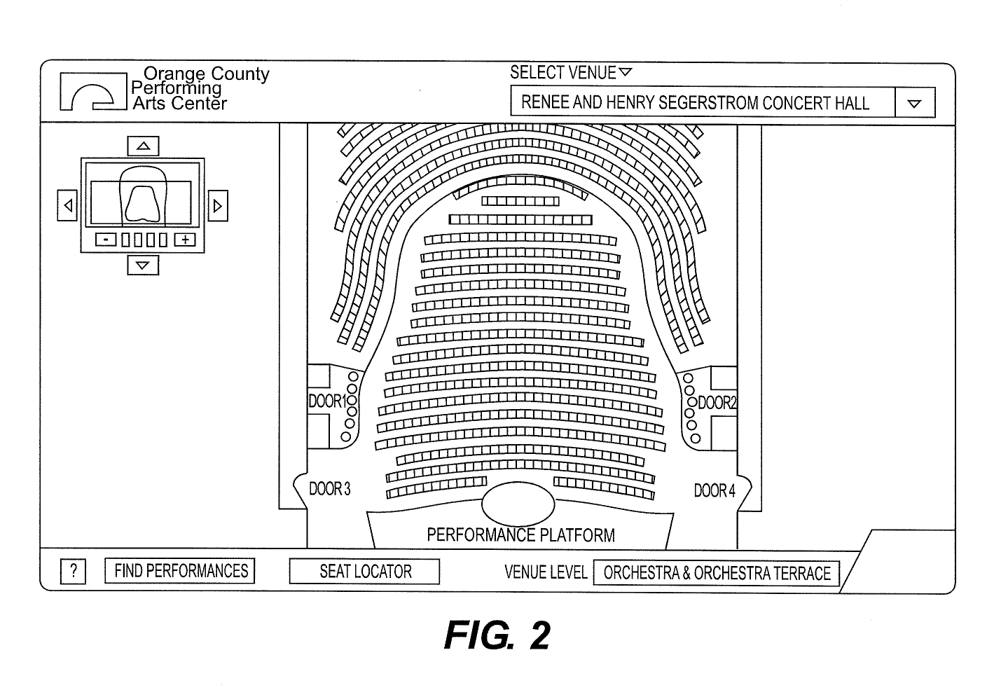

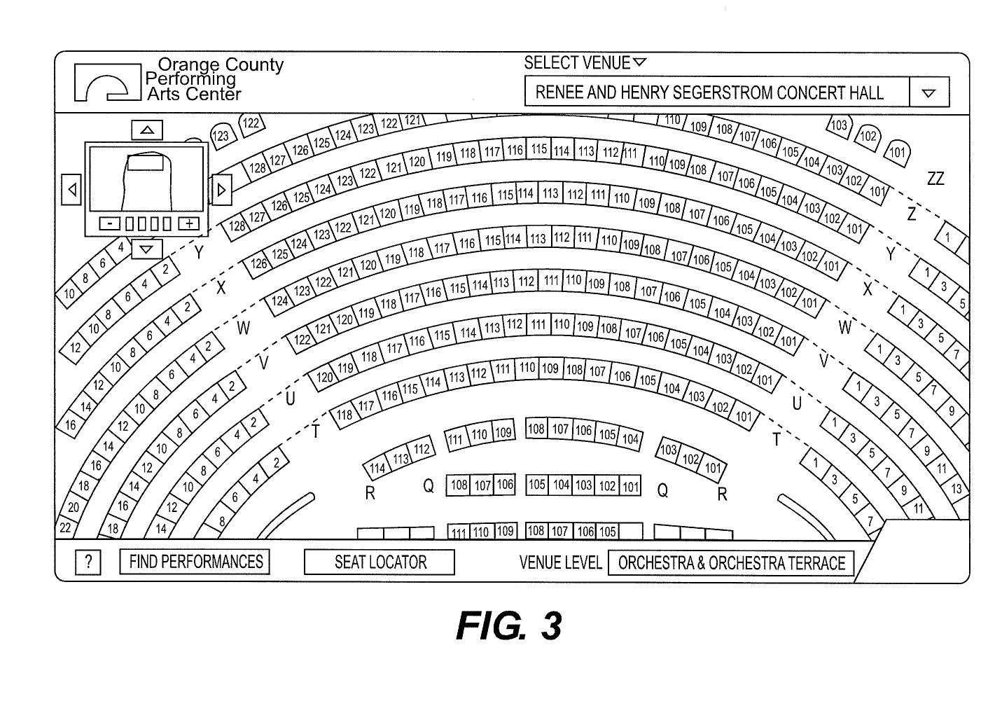

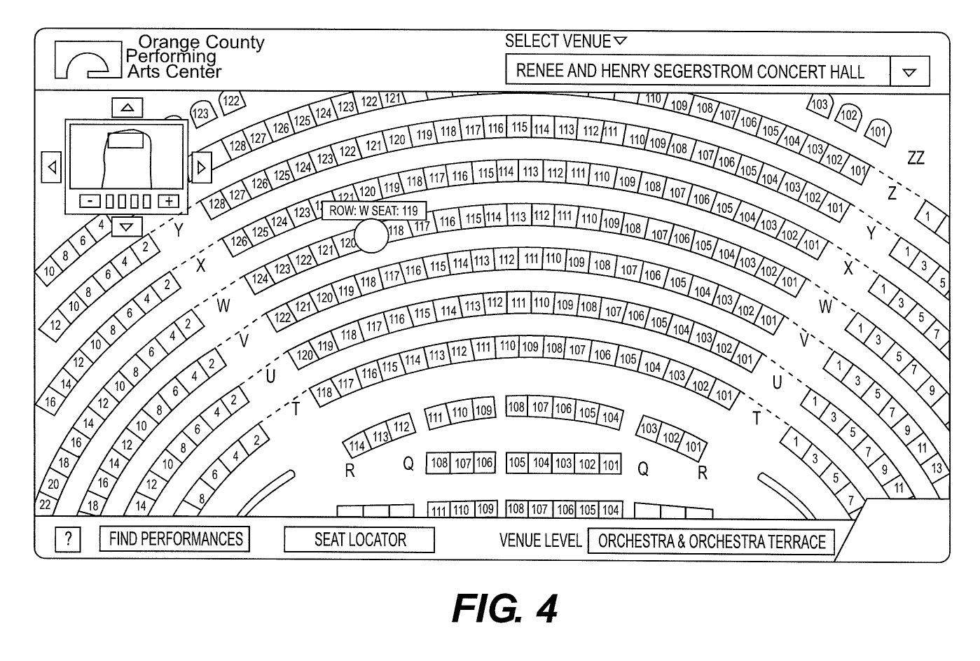

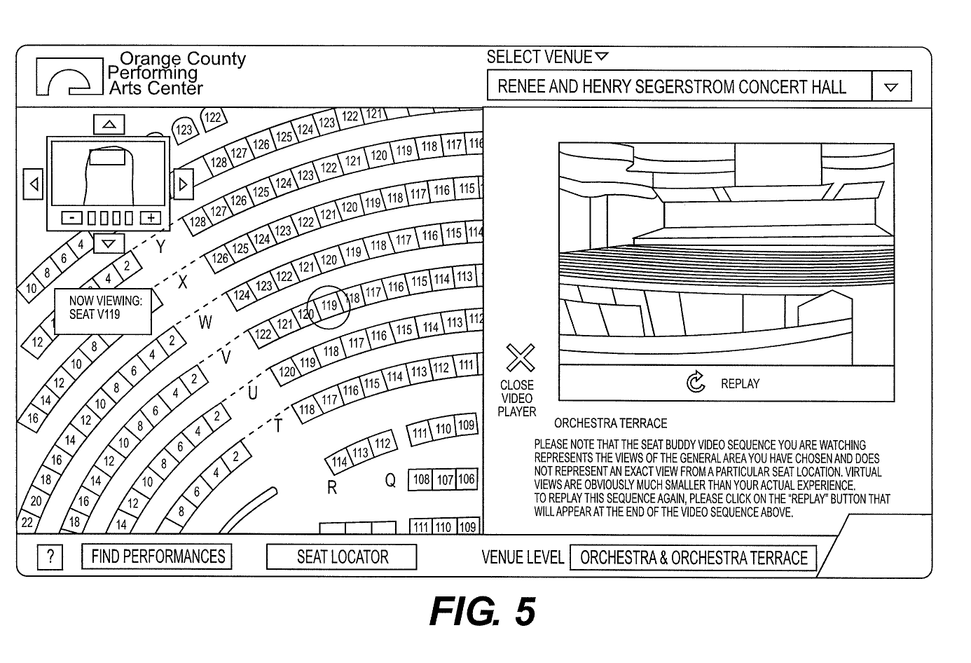

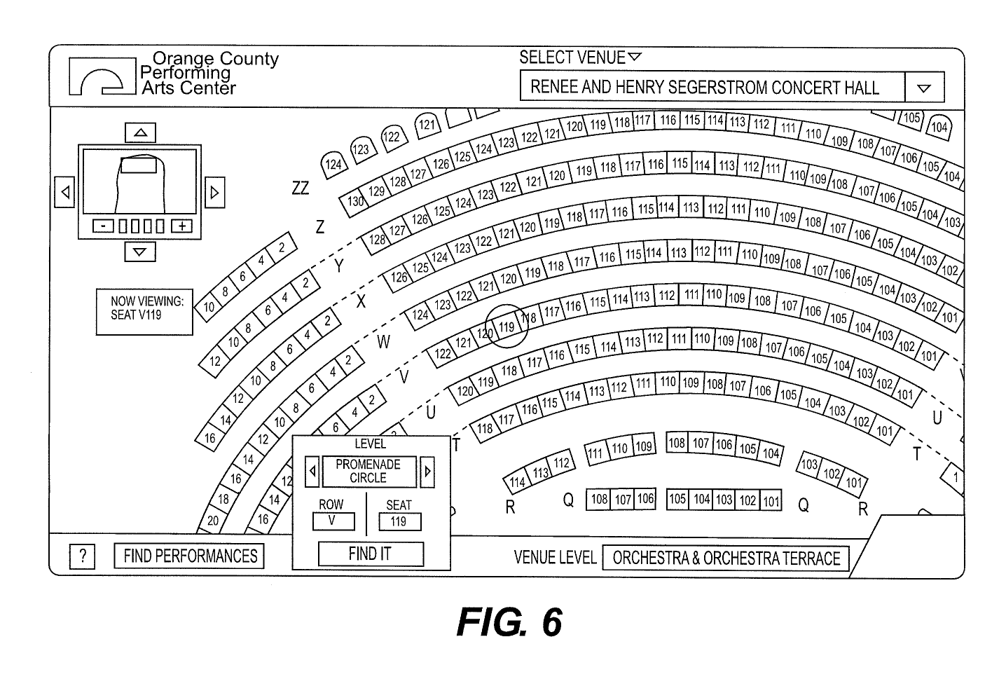

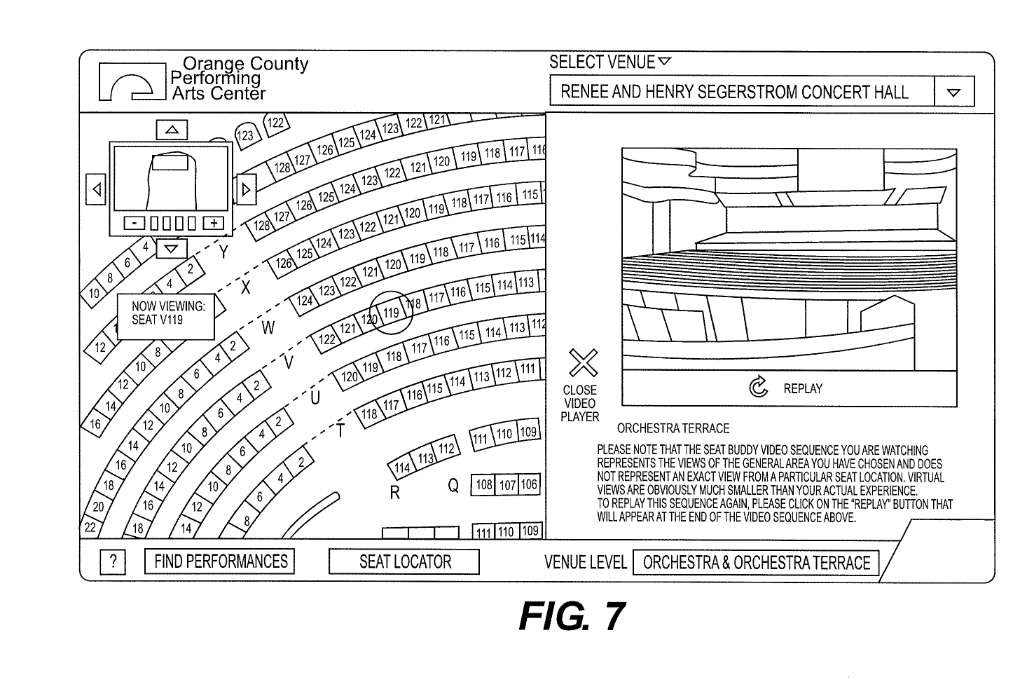

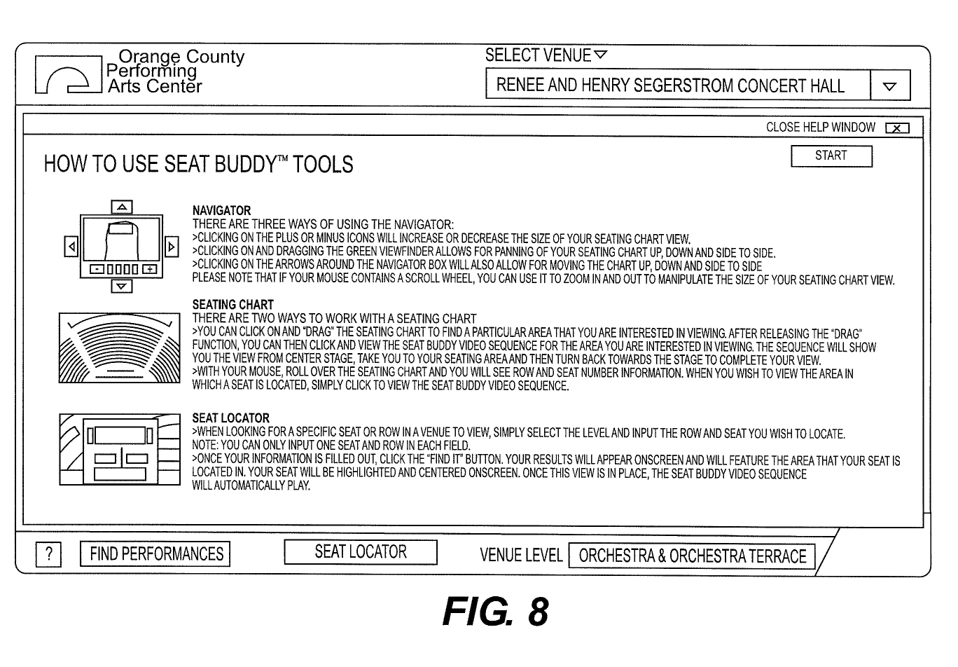

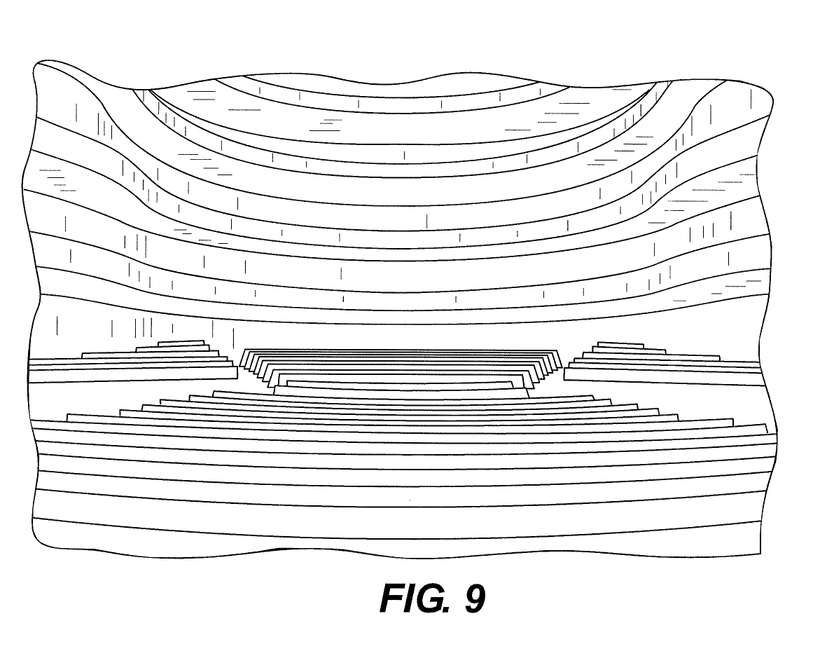

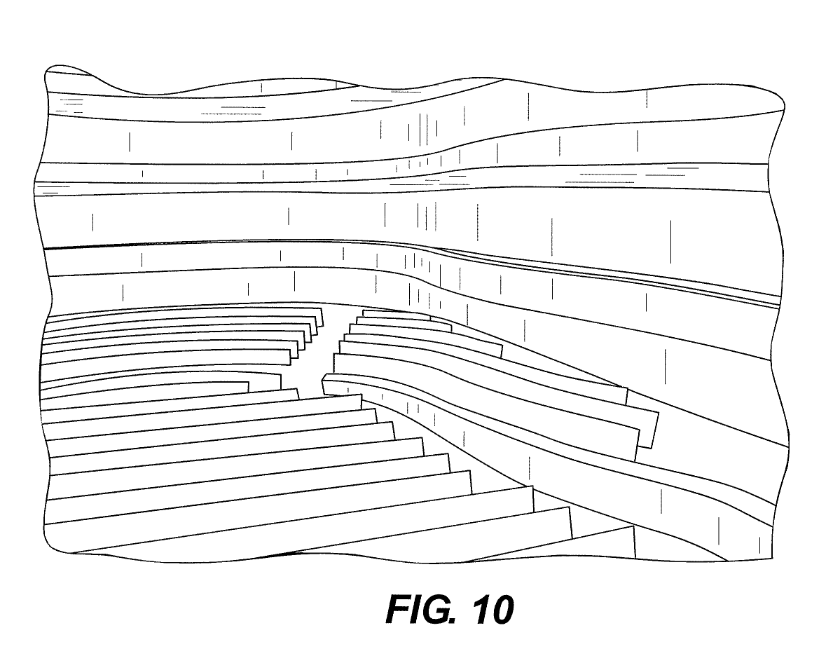

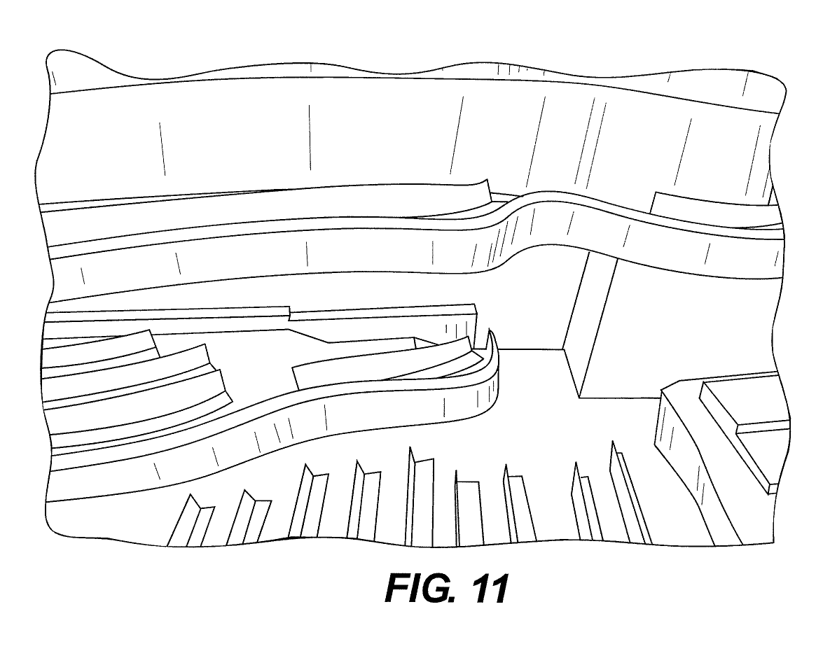

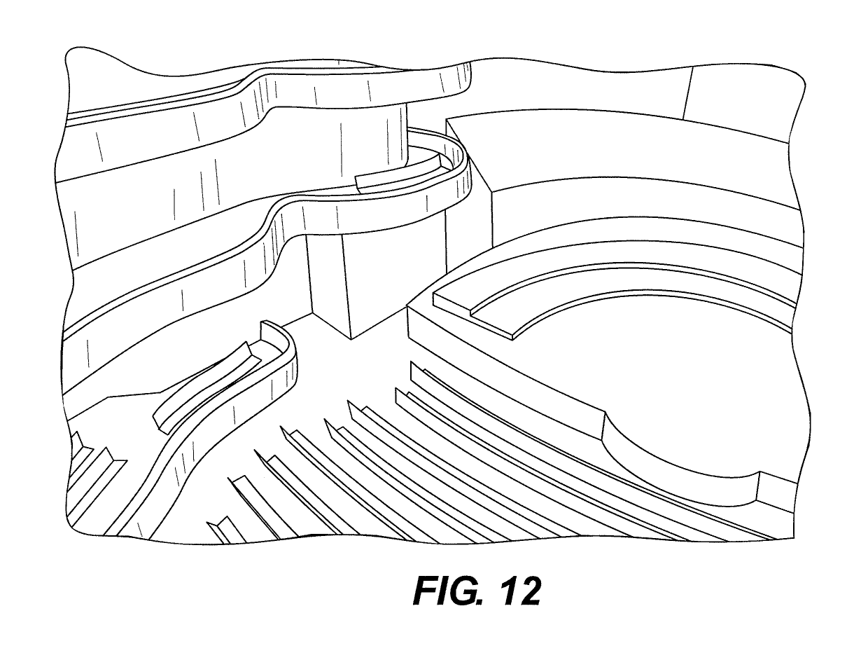

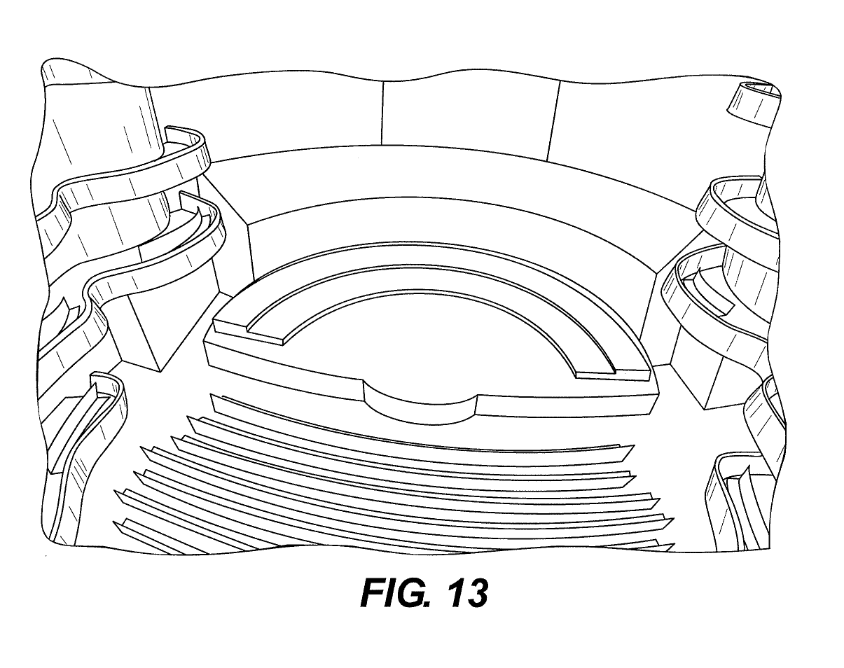

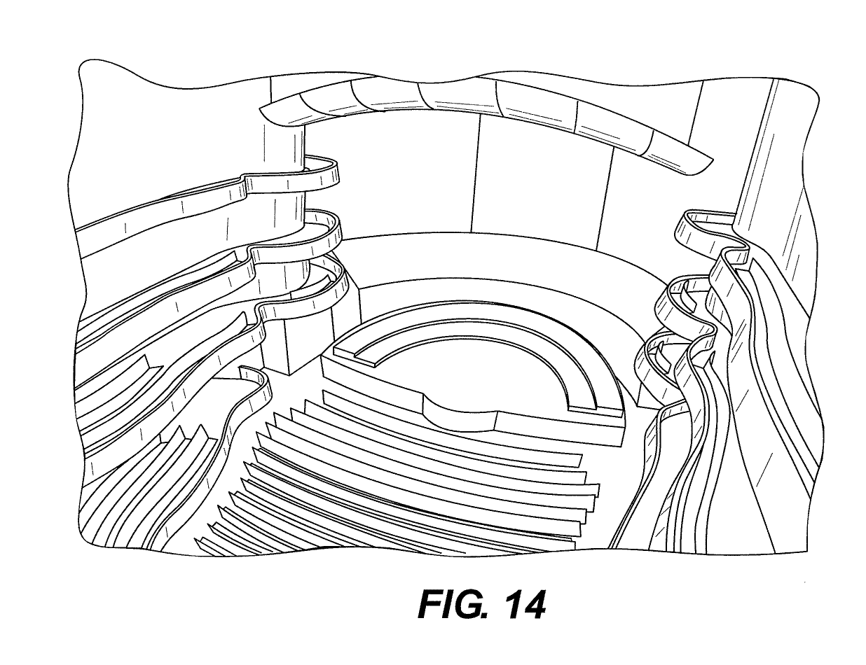

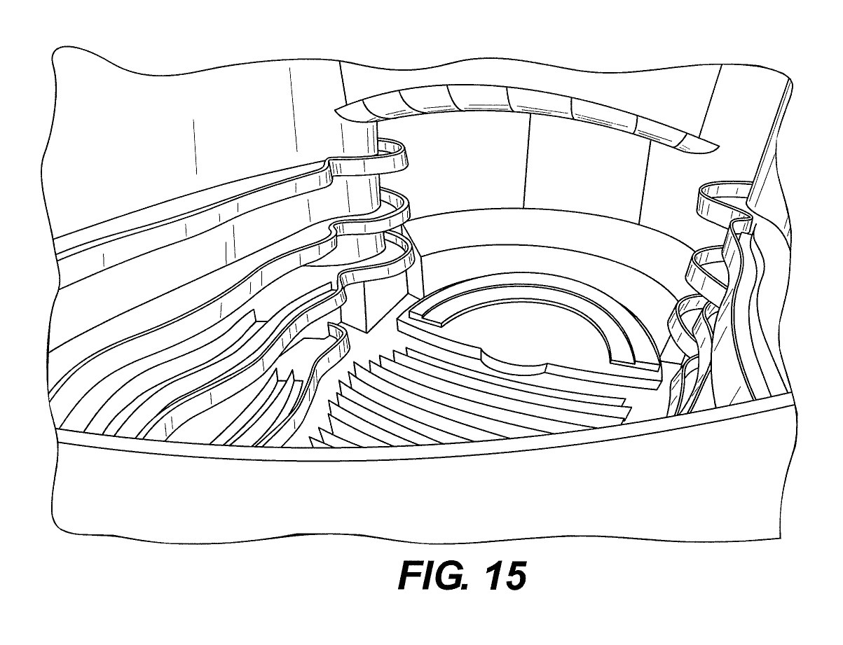

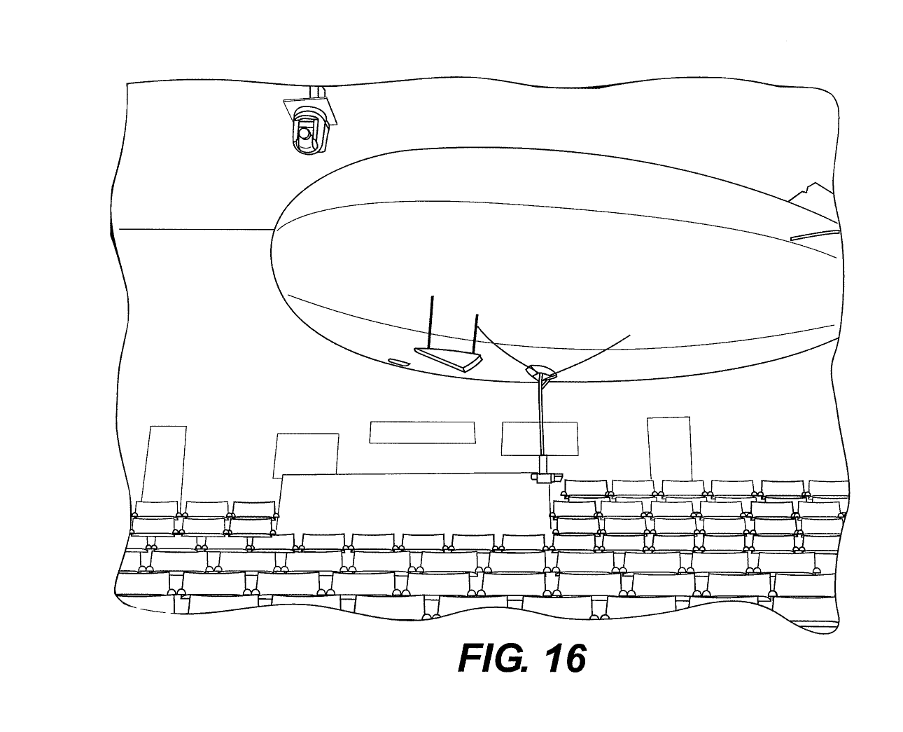

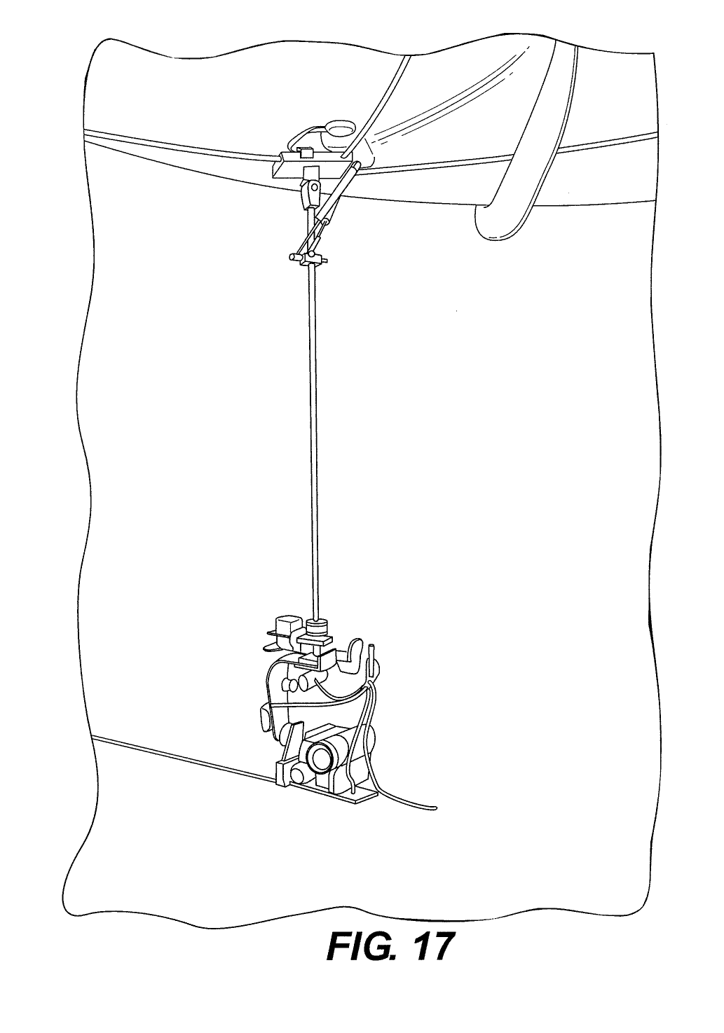

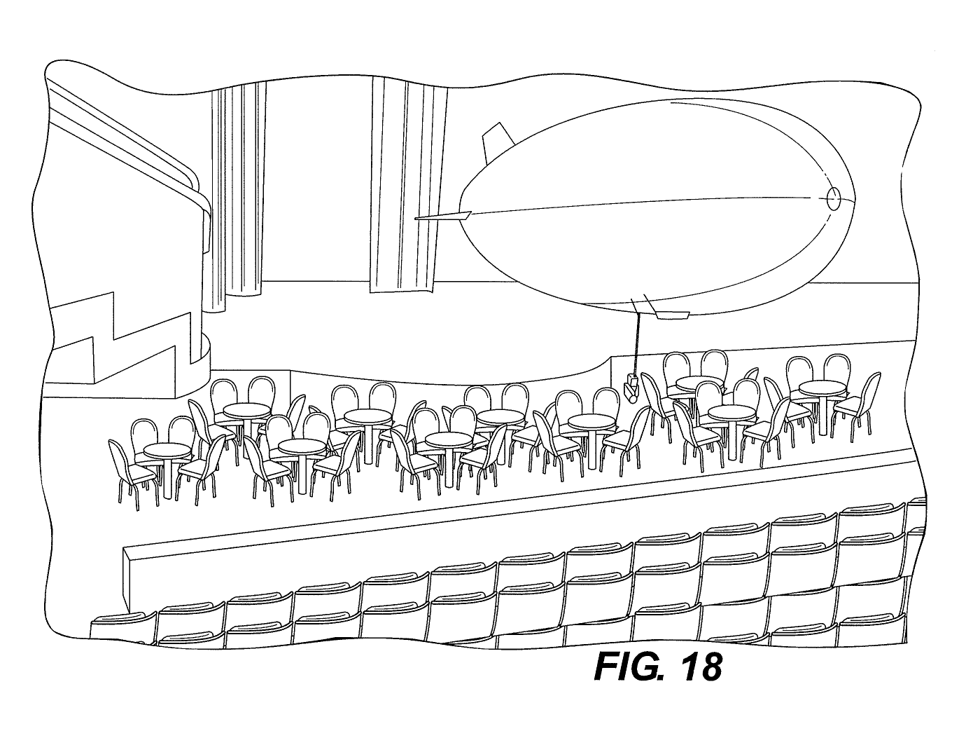

As shown in FIGS. 1-8, one embodiment of the present invention comprises a system for use with a website for a performance venue containing a seat selection tool, wherein the seat selection tool contains a video player that depicts a video segment showing the view from the stage of the venue's seats. In one embodiment, previously recorded video segments are stored and indexed in a database. When a seat selection is entered by the user, the video player plays a video segment showing the view of the seat selection from the stage, and then a dynamic view as recorded by the video recording device, for example, a camera, as it moves from the stage to the seat selection, and then a view of the stage from the seat as shown in FIGS. 9-15. The video segment may captured by a remote camera attached to an apparatus, including, but not limited to, a remote controlled blimp (as shown in FIGS. 16-18), crane, or guide wires.

One embodiment of the present invention further comprises a seat locator functionality. The tool allows an administrator to quickly and easily input row information into the seat selection tool. Using this tool, the administrator is able to enter all the information of a large venue (2000 seats) into the apparatus and system according to one embodiment of the present invention in a little over an hour.

In order to view a photo or video from a particular seat's perspective a user must identify a specific seat or section he would like to view. In one embodiment of the present invention, the system and method provides a perspective from a general section, rather than a specific seat, if the user queries a specific seat, that seat must be tied to a general section. There could be tens of thousands of seats in a venue making entering each seat into a database and tying the seat to a section very time consuming. One embodiment provides the administrator with an easier way of entering seats and associating them with a particular seating area by allowing the administrator to enter an array of seats into a particular section and associated video, rather than on a seat by seat basis.

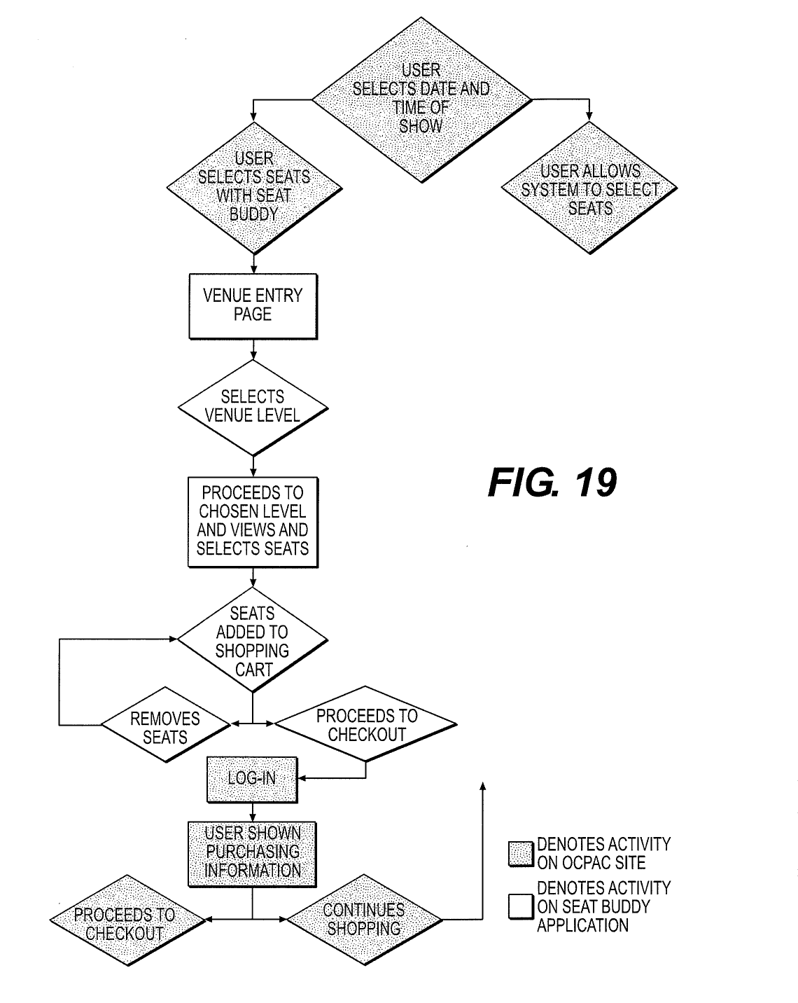

As shown in FIG. 19, one embodiment of the present invention comprises the software and hardware, or combination of both, necessary to allow the user to select a seat, view the video segment, replay the video segment, or choose another seat.

One embodiment of the present invention is an apparatus and system that may be used in conjunction with a website for a performance venue that provides a more realistic dynamic depiction of the view between a seat, section and stage, that will assist performance venues in selling more tickets to events. Users may be more likely to purchase tickets after viewing the video segment that they might otherwise not purchase because they are unable to confirm whether the potential view from the selected seat is sufficient for them to make an on-line purchase. By providing users with more information about the seats available at a venue, users will be better able to select tickets matched with their viewing requirements, and be more likely to purchase a ticket to a performance event.

An embodiment of the present invention is an apparatus and system comprising an interactive seat selection technology designed to enhance existing online selection features by allowing users to see the perspective of the stage they will enjoy from the seats as well as a video segment “flight” from their seat to the stage. From the stage the user can also see a 180 degree rotation view of their seat from the stage. The consumer is provided with a more realistic assessment of seating choices from two viewing perspectives—from the stage and from the desired seating area—providing a better measurement of where seats are located in relation to distance and view to the stage. Video footage created is entered into a database and then matched to the appropriate graphical representations of the seating plans of the venue. By clicking on a seat location the user is offered a 180 degree video view of the theater from the stage to the seating section and then back to the stage, providing the user the experience of the full venue in respect to their seat selection. The system is created by the production of a comprehensive and detailed video of each venue through the use of a remote control camera flown over the seats and stage. A proprietary flight and control technology has been modified to work in live entertainment environments with a high degree of accuracy.

### EXAMPLE

Testing included the utilizing of a camera, attached to the underbelly of a indoor blimp. This configuration was tested multiple times in creating the “stage to seat/seat to stage” video sequence that is an embodiment of the present invention.

The block diagram of FIG. 19 illustrates the steps or modules of the system and method of an embodiment of the present invention, wherein the user interacts with the seat selection tool within the venue web-site. The user may select, view, and purchase their tickets to a show or event.

One embodiment of the present invention provides venue seating charts featuring the “best available” seats within each venue level as the application will have the ability to communicate with a venue's ticket system database to display this and other pertinent information.

Numerous characteristics and advantages have been set forth in the foregoing description, together with details of composition and function. The novel features are pointed out in the appended claims. The disclosure, however, is illustrative only, and changes, may be made in detail, especially in matters of ranges of components and nutritional value, within the principle of the invention, to the full extent indicated by the broad general meaning of the terms in which the appended claims are expressed.

What is claimed is:

1. A system for the interactive selection of seats, comprising
A video segment created by moving a video recording device from a stage to at least one seat in a venue, from at least one seat to a stage, or both;
a storage medium storing the video segment;
a video player module enabling a user to view the video segment;
a selection tool to allow the user to select a seat at a venue and play the video segment assigned to the seat.

2. The system according to claim 1, wherein the video recording device is a digital camera.

3. The system according to claim 1, wherein the video recording device is attached to a blimp to record the video segment.

4. A method for the interactive selection of seats, comprising the steps of:
creating a video segment by moving a video recording device from a stage to at least one seat in a venue, from at least one seat to a stage, or both;
storing the video segment in a storage medium;
enabling a user to view the video segment using a video player module;
allowing a user to select a seat at a venue and play the video segment assigned to the seat.
